(19) United States
(12) Patent Application Publication
(10) Pub. No.: US 2025/0378293 A1
(43) Pub. Date: Dec. 11, 2025

(54) AMBIENT COMMUNICATION DEVICES AND METHODS FOR USE THEREOF

(71) Applicant: Oswego Technologies LLC, Columbus, NJ (US)

(72) Inventors: Raziq Yaqub, Lumberton, NJ (US); Kazuki Hayashi, Dayton, OH (US); Brian Gordaychik, Columbus, NJ (US)

(21) Appl. No.: 19/173,874

(22) Filed: Apr. 9, 2025

Related U.S. Application Data
(60) Provisional application No. 63/658,823, filed on Jun. 11, 2024.
(60) Provisional application No. 63/676,366, filed on Jul. 27, 2024.
(60) Provisional application No. 63/718,826, filed on Nov. 11, 2024.

(51) Int. Cl. G06K 19/07; G06K 7/00; G06K 7/10; H04L 27/26

(52) U.S. Cl. CPC G06K 19/0723; G06K 7/0008; G06K 7/10019; H04L 27/2607

(57) ABSTRACT

A method performed by a wireless device in communication with a reader may comprise transmitting an energy parameter, to the reader, using one modulation method of the group consisting of OOK and PSK, transmitting assistance device, to the reader, wherein the transmitted assistance information comprises at least a message size pertaining to the device, transmitting a message, having a cyclic prefix, wherein the message is consistent with the message size, on a bandwidth negotiated between the wireless device and the reader. The wireless device and the reader may be configured to communicate according to at least one application layer identifier having a random portion and a non-random portion, wherein the at least one application layer identifier is configured to be of at least two different lengths, wherein the at least two different lengths include a full length and a partial length.

### CROSS REFERENCE TO RELATED APPLICATIONS

This application claims the benefit of U.S. Provisional Patent Application Nos. 63/658,823 filed on Jun. 11, 2024, 63/676,366 filed on Jul. 27, 2024 and 63/718,826 filed on Nov. 11, 2024, the contents of each of where are incorporated by reference herein.

### SUMMARY

A method performed by a wireless device in communication with a reader may comprise transmitting an energy parameter, to the reader, using one modulation method of the group consisting of On-Off Keying (OOK) and Phase Shift Keying (PSK), transmitting assistance device, to the reader, wherein the reader is configured to receive assistance information about the device independently from the device and from another device, wherein the assistance information comprises at least a message size pertaining to the device; and transmitting a message, having a cyclic prefix, wherein the message is consistent with the message size, on a bandwidth negotiated between the wireless device and the reader. The device and the reader may be configured to communicate according to at least one application layer identifier having a random portion and a non-random portion, wherein the at least one application layer identifier is configured to be of at least two different lengths, wherein the at least two different lengths include a full length and a partial length. In embodiments, communication between the wireless device and the reader occurs on a negotiated bandwidth. The selected modulation is one of OOK and PSK, wherein the selected modulation employs at least two tones. A CRC length may be selected based on information that precedes the CRC, wherein the information that precedes the CRC is of a first length or a second length, wherein the second length is different than the first length. A CRC may not be used in some embodiments. A midable sequence may be variably employed. In a first mode, contention based access is provided between the device and the reader and in a second mode, contention free access is provided between the device and the reader.

A system may comprise a device and a reader. The reader may be configured to receive an energy parameter, from the device, in a transmission from the device to the reader. The reader is configured to receive assistance information about the device independently from the device and from another device, wherein the assistance information comprises at least a message size of the device. The device and the reader are configured to communicate according to at least one application layer identifier, which is configured to be of at least two different lengths, wherein the at least two different lengths include a full length and a partial length. An application layer identifier may have a random portion. A sequence number may or may not be employed. Modulation methods include one or both of On-Off Keying (OOK) and Phase Shift Keying (PSK).

### BRIEF DESCRIPTION OF THE DRAWINGS

FIG. 1 is a table illustrating code segments;

FIG. 2 is a network diagram of an ambient device network;

FIG. 3 is a network diagram illustrating simultaneous transmission from multiple access points (APs); and

FIG. 4 is a diagram illustrating prospective packet formats wherein midamble lengths are indicated.

### DETAILED DESCRIPTION OF THE DRAWINGS

The emergence of autonomous machines presents unique challenges and opportunities for emergency communication systems. Introduced herein is a specialized application of Multimedia Priority Service called On-Demand Multimedia Priority Service (OD-MPS), tailored to expedite, and prioritize communication for autonomous machines during distress and emergency scenarios. Autonomous machines may include unmanned aerial vehicles, self-driving road vehicles, sea vessels, critical assets capable of communication, and sporting gears used in high impact sports, among others.

Autonomous machines, such as Unmanned Aerial Vehicles (UAVs), Self-Driving Cars, and Crewless Cargo Ships, demand robust and prioritized communication capabilities during emergencies. While they may possess conventional emergency communication functionalities, they lack the preferential emergency communication features essential for swift transmission of critical information to emergency responders and pertinent authorities. This absence of specialized features in autonomous machines presents formidable hurdles in ensuring safe and dependable autonomous operations during emergency situations.

Multimedia Priority Service (MPS) is a telecommunications functionality designed to prioritize vital multimedia transmissions within traditional networks. Yet, current MPS implementations are tailored exclusively for authorized government personnel, necessitating pre-authorization and subscription through telecommunication providers. Consequently, this framework excludes autonomous vehicles operating independently, which may require immediate emergency connectivity on a prioritized basis.

Embodiments disclosed herein may be applicable to various platforms, such as Unmanned Aerial Vehicles (UAVs), Self-Driving Vehicles, and Crewless Cargo Ships and Marine Vessels.

The proposed OD-MPS empowers autonomous machines to independently solicit prioritized communication without necessity of pre-authorization or subscription requirements. This facilitates swift transmission of real-time multimedia data to designated government and emergency agencies on a priority basis. This functionality may be activated solely during distress situations, utilizing an automated distress alert system with integrated OD-MPS features, which automatically deactivates once the distress situation resolves. Additionally, granting priority communication status is suggested to specified emergency contacts exclusively during distress situations, even if they lack the privilege under normal circumstances.

OD-MPS empowers these machines to communicate critical information, such as live video feeds, sensor data, and distress messages, in emergency situations on priority basis on existing commercial telecommunication infrastructure. The automatic distress alert system comprises various components, including Automated Sensors designed to detect emergency situations by monitoring parameters like impact, water ingress, fire smoke, airbag deployment, and other abnormal conditions on board. Additionally, it incorporates Automated Machine Identification Systems and an Automated Vehicle GPS coordinates Identification System.

The implementation of OD-MPS within the 5G network involves several key components and functional entities. These include User Equipment (UE), which may be an autonomous machine or communication device, the gNodeB (or base station), and core network components such as the Policy Control Function (PCF), Session Management Function (SMF), Access and Mobility Management Function (AMF), Unified Data Management (UDM), and Network Slice Management Function (NSMF). These entities collaborate to ensure seamless OD-MPS for autonomous machines during distress situations. The entities and their roles in this context are as follows:

In the context of cellular OD-MPS, UEs encompass a wide range of autonomous machines, including UAVs (Unmanned Aerial Vehicles), autonomous ground vehicles, sea vehicles, and other devices designed for human and asset protection. These UEs are equipped with advanced communication capabilities to automatically send distress alert messages, triggering priority communication during emergency situations.

An OD-MPS Code, like a MAC address, may be hard-coded into autonomous machines by the manufacturer to prevent tampering and misuse. The provision of the OD-MPS Code to UEs, and the policies regarding its use-such as whether it is barred or not-may be governed by government regulations, manufacturers' associations, or both. These policies, along with the pertinent OD-MPS Code and the corresponding network actions, may be updated in the PCF.

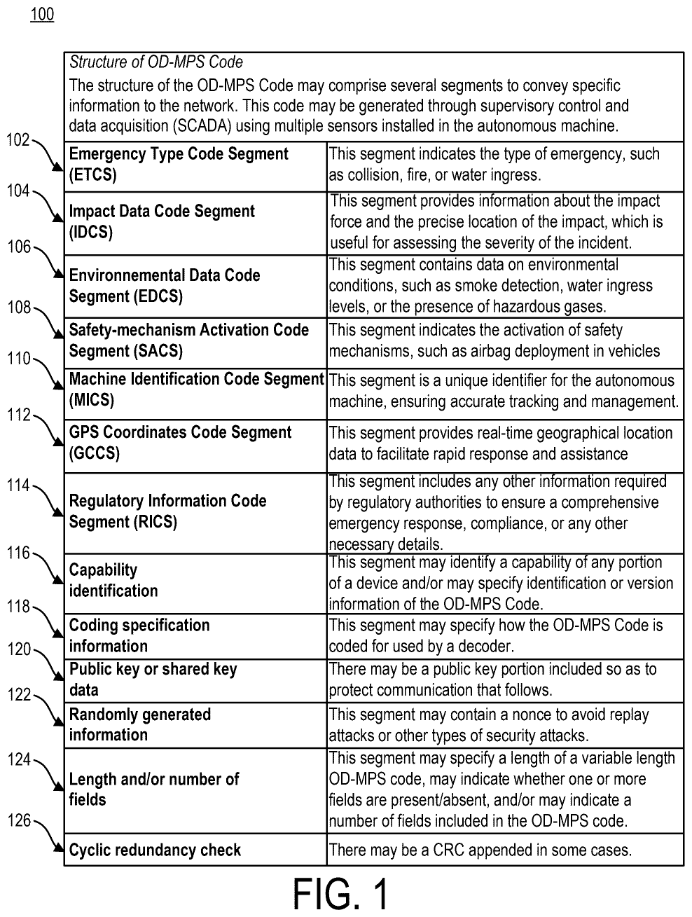

FIG. 1 demonstrates example elements and an example structure of an OD-MPS Code. The structure 100 of the OD-MPS Code may comprise several segments to convey specific information to the network. This code may be generated through supervisory control and data acquisition (SCADA) using multiple sensors installed in the autonomous machine. An emergency Type Code Segment (ETCS) 102 is a segment that may indicate a type of emergency, such as collision, fire, or water ingress. An Impact Data Code Segment (IDCS) 104 is a segment that may provide information about the impact force and the precise location of the impact, which is useful for assessing the severity of the incident. An Environmental Data Code Segment (EDCS) 106 is a segment that may contain data on environmental conditions, such as smoke detection, water ingress levels, or the presence of hazardous gases. A Safety-mechanism Activation Code Segment (SACS) 108 is a segment that may indicate activation of safety mechanisms, such as airbag deployment in vehicles. A Machine Identification Code Segment (MICS) 110 is a segment that may be a unique identifier for the autonomous machine, ensuring accurate tracking and management. A GPS Coordinates Code Segment (GCCS) 112 is a segment that may provide real-time geographical location data to facilitate rapid response and assistance. A Regulatory Information Code Segment (RICS) 114 is a segment that may include any other information required by regulatory authorities to ensure a comprehensive emergency response, compliance, or any other necessary details. A Capability identification 116 is a segment that may identify a capability of any portion of a device and/or may specify identification or version information of the OD-MPS Code. Coding specification information 118 is a segment that may specify how the OD-MPS Code is coded for used by a decoder. Public key or shared key data 120 may be a public key portion included so as to protect communication that follows. Randomly generated information 122 may contain a nonce to avoid replay attacks or other types of security attacks. A length and/or number of fields segment 124 may specify a length of a variable length OD-MPS code, may indicate whether one or more fields are present/absent, and/or may indicate a number of fields included in the OD-MPS code. A Cyclic redundancy check 126 may be appended in some cases. Any other parameter disclosed herein may be included as a segment.

An OD-MPS code may ensure that priority communication is established near instantly, enabling timely intervention and support, thereby enhancing safety and operational efficiency. An OD-MPS code may be transmitted/modulated according to any transmission/modulation scheme (for example modifying any one or more of phase, amplitude and frequency) disclosed herein.

Electric Vehicles (EVs) are now equipped with an eSIM, enabling them to function similarly to mobile phones in terms of connectivity and communication capabilities. This advancement significantly enhances the user experience by providing features such as real-time navigation, remote diagnostics, over-the-air updates, and seamless integration with third-party service providers, such as, for example, power utility companies.

The proliferation of EVs is exponential, driven by technological advancements and increasing environmental concerns. However, this rapid growth presents challenges for the existing power grid infrastructure. The grid often cannot support the simultaneous charging of multiple EVs due to limited power production capacities in certain areas, the risk of transformer overloading at specific times or under certain conditions, and generally inadequate distribution infrastructure.

Scheduled charging has been widely proposed to manage this demand. [e.g. 1]. However, this approach is not feasible for emergency vehicles, which require immediate and reliable access to charging. To address this issue, this paper proposes a priority charging service for government-authorized emergency EVs. This service includes preempting other EVs from charging and ensuring the continuation of charging for priority EVs in the event of transformer overloading, while shedding non-priority loads.

For the proposed priority charging service for emergency EVs, communication between the EV and the Radio Access Network (RAN) involves a series of radio access messages. These messages facilitate the identification, authentication, prioritization of emergency EV charging, and the management of the charging process. Below is a detailed overview of the types of messages that would be exchanged.

EV Identification and Authentication Messages may be used. Attach Request: When the EV first connects to the network, it sends an Attach Request message to the RAN. This message includes the unique EV identifier, which may be a combination of IMSI and Vehicle Identification Number (VIN). The RAN responds with an Attach Accept message if the attachment is successful. Note: The VIN's length (17 digits) versus the IMEI (15 digits) may require modifications in the RAN message format to accommodate the extended identifier.

An Attach Accept indicates the RAN's response confirming successful attachment. Authentication Request: The RAN sends an Authentication Request message to the EV to ensure secure communication. Authentication Response: The EV responds with an Authentication Response, including the code for government agency-owned emergency vehicles, code expiry date, and any other parameters mandated by government policies. This step validates the EV's identity and authorizes it to use the network services.

Priority Status Communication may be employed. Priority Service Request: The EV sends a Priority Service Request message to the RAN, indicating that it is an emergency vehicle requiring priority charging. This message includes the EV's priority level and relevant credentials to authenticate its priority status, such as a government-issued certificate or digital token.

Upon validating the priority status, the RAN responds with a Priority Service Confirmation message, acknowledging the priority request and allocating necessary network resources.

Devices may provide assistance information, including but not limited to: rain, fog, road condition, snow, ice, visibility conditions, interference from vehicles in lane or in perpendicular lanes, speed, location, observed vehicular density, etc. vehicle density may be predicted or estimated by a base station using techniques disclosed herein. Vehicles may report delay requirements, latency expectations, time to receive a grant, transmission data quantity, message size, and the like to a network or to other network devices.

A mobile device may receive an allocation based on assistance information provided by the mobile device, in combination with other parameters discovered by a base station or other mobile station as well as information collected from nearby mobile devices. The allocation may be provided via downlink control information (DCI), MAC or RRC and may be a one time allocation, static or semistatic allocation. The periodicity of resources allocated may be based on vehicle reported assistance information. That is to say, the mobile device may receive parameters indicating uplink resources based on a periodicity and depending on previous assistance information. If conditions are worsening, e.g. is snowing getting worse, the base station may allocated a different grant (e.g. a more frequent resource utilization). If conditions (e.g. road conditions, snow conditions, etc.) are lessening, then maybe cut back periodicity by a percentage to match the newly reported assistance information.

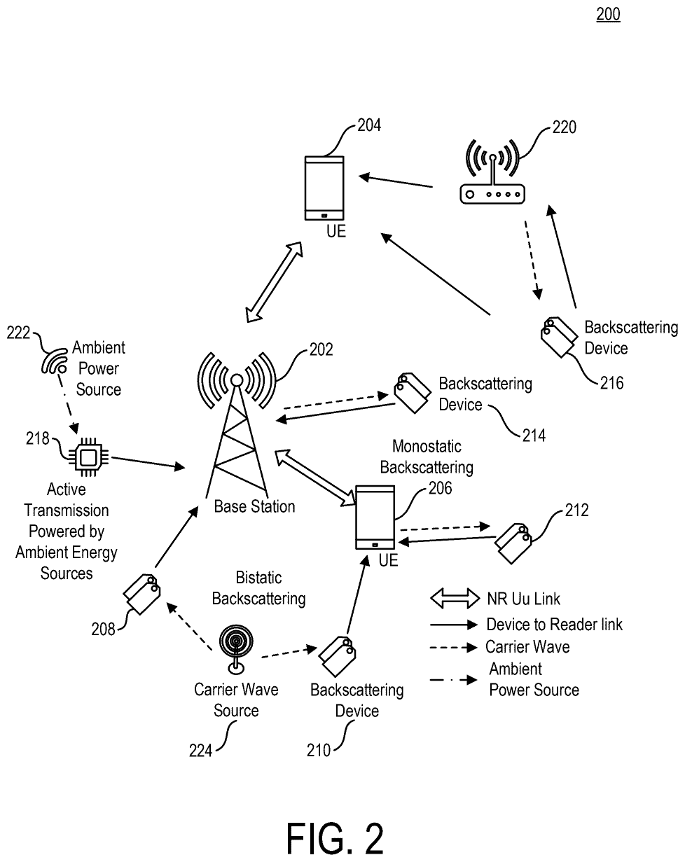

FIG. 2 is a network diagram of an ambient device network 200. The ambient device network 200 may comprise a base station 202, a plurality of UEs 204, 206, backscattering devices 208, 210, 212, 214, 216, an active tag 218 and one or more 802.11 complaint access points 220. Active tag 218 may be powered by ambient power source 222. Backscattering devices 208, 210 may be powered by carrier wave source 224. In embodiments, backscattering device 216 may receive ambient power from AP 220 and provide information to both AP 220 and UE 204. UE 204 may receive information in parallel or in the alternative, from backscattering device 216 via AP 220. See Ambient IoT: Redefining Wireless Communication for Industry 4.0 By Jyotirmay Saini, Suman Malik, Shyam Vijay Gadhai, Rohit Budhiraja, IIT Kanpur/TSDSI which may be found in 3GPP Highlights Issue 8, published online at www.3gpp.org/highlights.

A base station may provide a UE with resources for transmitting additional assistance information based on previously provided assistance information. Based on a combination of new and old assistance information, the base station or other station may provide a resource grant which indicates resources of different technologies. For instance, the base station may indicate to a mobile station to use RF resources of a certain periodicity, pool, etc. (which may be provided by higher layer signaling). The base station may also indicate that the mobile station is to aggregate resources of another technology, based on a resource pool that the UE selects from autonomously or that the base station provides an indicator for. For instance, a base station may provide DCI that indicates an RF resource to transmit on and conditions for which the mobile station may aggregate resources in the visible light spectrum (e.g. resources for transmission via the headlights, taillights or other vehicle light based indicators. Other technologies may be used without limitation. The base station may be a local base station, for example, a street light or sign, or may be a greater distance away. The DCI may comprise other parameters as disclosed herein. In some embodiments, the resource grant(s) may be based on a capability exchange between vehicles and an indication of that capability may be provided by the vehicle to a base station in advance of the assistance information or in advance of the resource grant. In some embodiments, the UE may receive a preconfigured pool of resources of the non-RF band to use or the UE may select fully autonomously based on an exchange of information with another vehicle or another device.

A vehicle may report whether a resource grant corresponds to a life critical message being transmitted or broadcast, via the assistance information. The grant of resources may include or exclude certain rf or non-rf resources, based on the communication urgency or priority. A vehicle or other device may transmit on non-rf resources which are scheduled to other devices, in cases where the priority exceeds a threshold. In these cases, the base station may provide an indication, via RF, for the other transmitting devices to cancel transmission on the non-rf bands. When a vehicle transmits a message using headlights, taillights etc., the vehicle may adjust the duty cycle of the visible light to both warn another driver (e.g. by flashing lights as one would normally do manually in combination with modulating and driving the lights to convey information to a VLC receiver).

In the case of wireless vehicle charging, the vehicle may use headlights or tail lights to convey information (VLC) to a device located at a wireless charging station. Communication messages may be exchanged via VLC to convey information as to battery charge state, priority information, begin/end of charge, etc. Similarly, the lights may simultaneously provide visible indicators to an operator of the vehicle that charging has begun, ended, or any other indicator of charging, etc.

Devices may use a request/response scheme to provide assistance information to a server which is or is not located within a cellular core network and may not be located with a cellular network. The request/response may be a codebook request/response. The request may include: supported codebook identifiers or subsets of codebooks already in use or expected; location, position, speed, trajectory, vehicles in sight, obstruction information; video, image and audio information; a priority or set of priority information elements; terrestrial, airborne, mobile indications; information discovered based on ultraviolet, visible or near infrared light based sensors; sensor make, model, type, identifier number; lidar information, e.g. backscattering information including whether one or more of Rayleigh, Mie, Raman and fluorescence scattering are used for lidar; frequency, time, beam information; an array or list or other data structure comprising information on the objects in view, including heir distances, directions, size, doppler, location in 3 dimensions, etc. the data structure may indicate whether certain devices have a given capability that is discovered by the device transmitting capability and/or device identifier or via a request/response to the device in some cases. The request may indicate beam information received from streetside cameras and streetside transceivers. The request may indicate a priority level for multimedia transmission. Any request/response protocol herein may incorporate a domain name service (DNS) protocol for identifying a server for routing a request and/or providing a response.

An IRS Gateway plays a role in the proposed architecture by facilitating seamless communication and resource optimization between networks associated with multi-SIMs in a single UE (User Equipment). The primary functionality of the IRS Gateway is to mediate interactions between different mobile networks pertinent to the involved SIMs, ensuring efficient utilization of radio resources by the multi-SIM carrying UE and minimizing redundant signaling. By establishing a centralized point for managing inter-network communications, the IRS Gateway enables real-time coordination between operators, leading to improved network performance and resource conservation.

One of the functions of the IRS Gateway is to handle the SIM Interaction Setup process. When a UE with multi-SIMs initiates a request for inter-network cooperation, the IRS Gateway receives the interaction request and validates the credentials and parameters of the involved SIMs through communication with the SIMSer, as explained in the next section. This validation process involves checking the authentication details, subscription profiles, and network policies to ensure compliance and security.

Upon successful validation, the IRS Gateway coordinates with the core networks of both SIMs to establish a synchronized communication session. This process involves exchanging essential parameters such as encryption keys, QoS (Quality of Service) requirements, and priority settings. The IRS Gateway sets up a secure interaction session ID, ensuring that both networks are aware of the ongoing cooperation and can manage resources accordingly. Additionally, the IRS Gateway facilitates the negotiation of bandwidth allocation, latency requirements, and handover parameters to optimize the session's performance.

Devices may negotiate terms such as bandwidth allocation, priority levels, and service quality, ensuring that the interaction is optimized for both performance and security.

In embodiments, a UE may negotiate wake up parameters. For example, a device may not know in advance that it is waking up a cell and may perform a normal PRACH transmission without specifically instructing a wake up signal. For example, a PRACH parameter for wake up may be included in a message format, such parameter may not be set by a transmitting UE, and a cell may be woken up regardless. The UE may wake up multiple cells based on transmitting a wake up signal (for example using on off keying OOK or another modulation type or protocol). In embodiments, the number of cells woken up may be based on a beam, frequency, time, data amount, amount of data waiting for the UE at the network, an expected uplink or downlink data quantity, a threshold value or the like.

Wireless devices and systems may employ flexible antenna arrays, wherein antennas are moveable (flexible) according to the channel conditions (e.g. fading, diversity, noise, interference, etc.). receive side devices may determine signal to interference and noise differences on spatial streams used on different frequencies during distinguished time periods. Flexible antennas may be used to form beams that are atypical in nature, for example, rainbow shaped, parabolic, etc. by changing a wavelength of a beam and using modulation techniques including pulse amplitude modulation (PAM), on off keying and adaptive discrete multitone (DMT) in which frames may include a plurality of types of modulation schemes.

Channel state information (CSI) may be configured/indicated with an association identifier that is packaged and may be associated with other signals herein. Various CSI lengths and feedback bitlengths may be employed using signaling via RRC or DCI to indicate length. In embodiments, communication may begin in an OFDMA and switch to a non-orthogonal multiple access scheme based on a number of free antennas available at wireless devices, for example, base stations, relays and UEs. In embodiments, the system may also revert to a non-timing aligned multiple access scheme, where transmissions are neither aligned in frequency nor in time, again, based on a threshold number of extra available antennas at devices. Indication to switch to a different type of access scheme may be depending on a network topology, for example, cell based or cell free, and may be based on calculated extra antennas available at each wireless device.

A combination of cell based and cell free technologies may be used in embodiments where channels or carriers are aggregated. As channel rank increases, flexibility in access scheme may be employed. Devices may share such information with one another via DCI, MAC or RRC layer signaling. Orthogonality may apply to certain devices and not others, for example, certain release versions may ensure tight channel and time orthogonality, while newer upgraded devices may not have to rely on the same so long as the base station is of higher capability.

There may be some alternatives to OFDM that may be employed in combination, for example, using only certain frequences for OFDM and dedicating other frequencies to space-division multiple access (SDMA), layered-division multiple access (LDMA), rate-splitting multiple access (RSMA) and/or multi-user superposition transmission (MUST) any combination thereof.

Rate splitting multiple access (RSMA) is a technique in which interference is partially decoded and partially considered as noise. Messages (downlink or uplink) including data and control messages may have two parts including a common part (common to all users) and a private part (which is received by a single UE or may be received by a group of dedicated devices). Once a receiver receives both the common part and the private part, a user decodes their message. Both the common part and the private part may vary in length and may include any parameter here. The length of the common part and length of the private part may vary based on interference levels, data to be transmitted, and priority. It may be that the common stream is beamformed to a group of users while the private portion is directed at a single user. It may also be that common streams are individually pre-coded to each receiver and transmitted simultaneously on same or different channel resources. The common segment may include both data and forward error correction information for both users. The common segment may include resource information for both users in the uplink or downlink direction and may thus comprise dci type parameters disclosed herein. The common portion may include reference signal information (for example, DMRS) and other measurement parameters.

Header formats may convey any modulation formats and coding schemes as disclosed herein. Header formats may be extended to serve up to 256 or 512 stations in a schedule, for example, by appending or prepending a single or double bit field to an existing 7 or other bit length field. In embodiments, transmissions may be broken up using a SBFD header and IBFD payload or vice versa. The header portion may comprise information disclosed herein and may convey information about the payload information, such as transmission length, duration, size, etc.

In a preferred embodiment, modulation may encompass On-Off Keying (OOK) and/or Phase Shift Keying (PSK) in combination with multitone modulation, i.e. two or more single tones. Modulation schemes may be indicated in the alternative, i.e. one or another. A selected modulation scheme may by hybrid in nature and employ a combination of two or more schemes. For example, a single packet, frame PPDU, or the like may employ multiple (for example, 2-3) modulation methods wherein a first modulation method is a lower speed/coding than a following modulation method. The second (or third) portion may be sent with a higher or lower power or at a different beam or angle, etc. Certain frame formats, for example, PPDU frame formats, may be transmitted one directly after another or with a brief interval in-between. A first PPDU may specify a timing, for example, a SIFS (or more or less time), in-between another PPDU of a same or different format which is to be transmitted from a STA to another STA or to another AP. The second PPDU may be transmitted to the same device or to another device in a same or another BSS. The first PPDU may provide other information, for example, a modulation of the second PPDU, a type of PPDU, whether the PPDU will be on the same BSS or not, whether the second PPDU is on a same or different channel, etc. Any parameter disclosed herein may be included in the first PPDU to signal information about the second PPDU. The same approach may be used for cellular and other technologies, including wired technologies. A receiver may confirm safe receipt of one PPDU and not another PPDU. If there is a collision of the first or second PPDU, the receiver may indicate such to the transmitter.

Various types of coding may be applicable at the sender/receiver side. For example, LDPC codes, turbo codes and other code techniques may be employed. A message may be merged with parity bits to create a codeword for transmission. A code rate, code length and method may be selected based on DCI, RRC or other signaling. In embodiments, random values may be incorporated into the encoding process to enhance security. The random values may be based on any parameter disclosed herein, for example, including but no limited to UE address information. A random parameter may be used in redundant retransmissions by employing the random number in starting, ending or length calculation of bits selected for a subsequent transmission.

A transmitter may use certain techniques, including varying power, varying direction, varying modulation (or varying certain modulation parameters), that make a transmitted signal look like noise to the third party. The sensing signal may be encoded based on a key, or the transmitting parameters may be selected based on a random number or keyed selection, thus the receiver and third parties may see the signal as noise. Alternatively, the key may be passed to the receiver via a data only communication or a data/sensing based communication.

In embodiments, devices may use modulation and coding techniques to transmit on contention based resources an indication that the group based SSB is received. Similarly, when a UE receives the UE specific SSB, the UE may indicate successful reception by transmitting RACH on contention or contention free resources of a same or different frequency band than which the UE specific SSB is received on. UE specific may have a greater or smaller frequency utilization than the group based SSB. UE specific may have a greater or smaller time utilization than the group based SSB. UE specific may have a greater or smaller beam utilization than the group based SSB.

Based in part on supported parameters, including modulation parameters, devices may predict a set of future beams, based on a set of beams utilized in the past at given times, locations, angles of operation, etc. beam prediction may be based on information received from other UEs, for example, via sidelink communication or via a base station. Prediction parameters for measurement and other prediction may be provided via RRC. The UE or BS may then monitor the quality of transmission or reception based on beam selection and feed back information for making future estimates and learning. N may be different depending on whether the beam prediction is made in spatial domain vs. time domain.

AI/ML techniques may be utilized to determine a number (N) of reports to make and/or a number of reporting instances for inclusion in a report. The number N may be based on higher layer signaling, for example, MAC/RRC layer signaling. In some cases, N may have a fixed maximum or may be based on conditions including: signaling quality, CSI/CQI, quantity of each report element, for example, if a reporting element is a certain bit length, the N may be larger if the bit length is lower than a threshold. In embodiments, if a UE is not expressly configured with N, the ue may report its selected N in advance by indicating a length field, number of bits, number of reported elements, etc. in a data structure for which the information is transmitted in.

Transmissions may be performed in a distributed fashion, for example, transmission may be made on subcarriers across one or more bandwidth allocations. In some embodiments, transmission resources may span multiple carriers with interspersed frequency portions not transmitted on due to detected busy or via sensing methods. This may apply to various transmission methodologies and/or topologies (e.g. point to point, mesh or broadcast).

Ambient devices, for example, readers and devices, may have certain modulation formats used for transmission between them. In embodiments, both types of devices may use on off keying modulation as a base modulation. The base modulation may be OOK1 or OOK4 with variable configurations for value M. modulation formats may use any of the following combinations per R1-2400331: Line code, PIE/Manchester; Line code, Manchester/Miller code/FM0; FEC (e.g., convolutional code)+Line code; and FEC (e.g., convolutional code). In embodiments, a modulation switch may be made based on any one or more of the following parameters: channel state information reception information, distance, power, location, observed ambient conditions, data rate, successful packet reception, etc. Based a parameter being detected to exceed a threshold condition, a transmitter or receiver may determine that a modulation switch needs to occur. Modulation switches may occur based on the following order: Line code->PIE/Manchester, Line code->Miller code, Line code->FEC code. Alternatively, or in combination, the devices may determine to switch between a forward error correcting code to a line code, miller code, or pie/Manchester code. In some embodiments, a packet format may be standardized in which the switch is built into the packet format.

In embodiments, packet format #1 includes a line code and an FEC type coding which follows, packet format #2 includes a FEC code and a miller code which follows and a packet format #3 may have one or more of the preceding modulation formats followed by a more advanced modulation scheme (of any format disclosed here). A subset of the packet formats may include a convolutional code and/or tail-biting convolutional code.

When a packet format switch occurs, it may be prudent to also switch to a different multiple access scheme. This may also occur on the presence or detection of multiple devices being in range of a receiver, for example, at a certain time of day, or also may occur when a reader is aware that more than one device may be present or nearby. For example, a time duplex scheme may be employed with a certain packet format with another packet format applying with a frequency division scheme.

Supported capabilities and topologies are listed. If a certain topology is supported, then a given X capabilities are supported, if a certain topology is supported on top of another topology, then given X+Y capabilities are supported. An identifier may be used which correlates topology and topology. In some embodiments, a capability ID may be identified first by a topology and then by a capability identifier within the topology (or vice versa). Capabilities may be inferred based on the combination of identifier and topology. Devices may be capable of asynchronous or isochronous communication, support all or only a subset of available of RF channels, connectionless or connection oriented and may be either bidirectional or unidirectional in certain transmission modes.

Mobile stations, base stations and network elements may support wireless protocols that are contention based and non-contention based on same spectrum resources. For example, airports are using a 30 MHz band from 5000 MHz to 5030 MHz and a 59 MHz band from 5091 MHz to 5150 MHz. MS and BS may operate WiMax, NR and/or Wi-Fi based protocols. In embodiments, a base station may be a cellular base station, for example, a gNB that operates according to 3GPP cellular protocols in a subset of the spectrum dedicated for airport use. For example, a NR compliant BS may operate on a set of 5 MHz channels, while the other channels (or another subset thereof) are used for Wi-Max protocols, e.g. 802.16. In this way, a mobile station, for example, an airplane or transceiver located in an airplane may use either technology or may use both technologies in parallel. In embodiments, Wi-Max may be used to support a primary cell supporting certain applications, while NR is used as a secondary cell dedicated to certain other applications. This may support backwards compatibility in that it may take some substantial time for legacy aircraft to upgrade to support NR. Base stations and network nodes may determine, based on channel occupancy, and airplane capability whether to dedicate more or less channels to NR as opposed to Wi-Max. An MS may have the option to chose one of a Wi-Max BS or a gNB base station. Each base station may be coupled to an ASN-GW.

Data packets may have a header portion, a payload portion and a trailer portion. Any of the fields specified herein may be fixed or variable in length with a portion (header, payload or trailer portion) indicating a length. The header portion may comprise a length field (e.g. chips), a modulation field indicative of a modulation used for a subset of the header portion and/or modulation used for a field which follows the header portion. In embodiments, the modulation method and/or modulation speed may change according to fields specified in the header portion or elsewhere. Each field of the packet pay have a fixed or variable length and thus the length may be decodable via a field in the header or other portion of the packet. The length may specify a number of timing units and/or number of bits/bytes etc. In embodiments, the header field may comprise a sequence number, data unit indicator, there may be one or more flags set based on the present/absence of any field herein within any portion of the packet. Header portions may include encryption information for remaining fields of the packet. There may also be FEC parameters and CRC parameters included. Header portions may include information on energy harvesting parameters, clock synchronization (rising edge or falling edge may be specified), backscatter parameters, reflection amplification, cyclic prefix, line code type switch parameters, band size of payload (for packets with larger frequency domain payload sizes than in header), scrambling, synchronization type for payload portion, number of chips used for OOK, bit sequence for mapping between bits to line code words, time domain specification in chips, frequency domain definition in terms of OFDM symbols, whether symbols are allocated in order or whether puncturing (in the frequency, time or beam direction/angle) is applied on certain symbols and resource unit allocations. In some embodiments FEC type may be specified or implied based on a transmission type or packet format. Header formats may specify CRC type, e.g. what polynomial is assumed for CRC generation and where the CRC is located in a packet. This may also be based on packet type/transmission type/topology. Header formats may specify a packet type correlated with a frequency domain size allocation, e.g. a bandwidth and also associated with a packet length. A smaller bandwidth data packet may be longer in size. The converse of this may also be true. For example, a transmitter may transmit a first packet having a bandwidth larger than a second transmitted packet despite the second packet being shorter in length than the first packet. Packets may be modulated differently, even though there may be more information potential, and thus packets may have a same information size.

Newer devices (or higher capability) devices including STAs have more significant latency concerns than older devices, e.g. older laptops and old cell phones, etc. A base station, e.g. an AP may warn devices that legacy devices including STAs may cause power draining issues. This may be done by issuing an HTTP response to an HTTP request by a STA, for example, by issuing an HTTP response including some HTML that indicates a message to the user regarding the power drain. This may only be done on a first http request, or it may be done periodically.

An AP may use an AI algorithm to determine whether to enter into a power save state. For example, the AP may monitor connection information including connection requests, beacons of other APs and monitor this information over a time period. The AP may correlate this information with a time of day, day of week, etc. and may determine presence via wireless sensing. An AP may determine to enter a power save mode, based on this information and/or other historical information.

Upon entering a power saving mode, a device may relocate other devices to another operating band or frequency. It may also determine to shut off certain bands or frequencies and/or reduce transmit power for itself, neighboring device and devices in range.

Base stations and other network elements disclosed herein may power down or enter a power save state in between messages exchanged between a wireless device and the base station. For example, a base station may reduce power, cull a link, bandwidth part, band or frequency, upon reception or transmission of any message herein while the base station has a time period of inactivity.

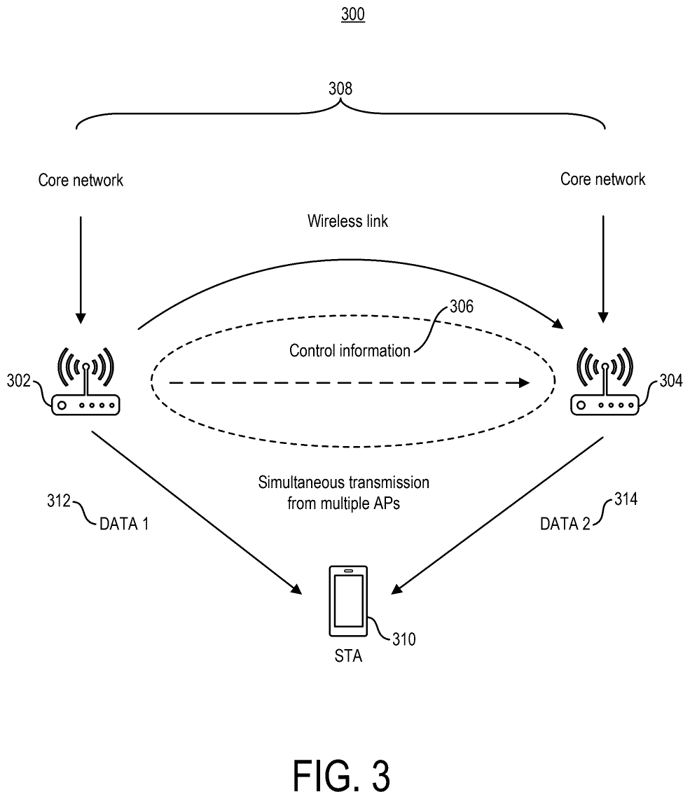

FIG. 3 is a network diagram 300 illustrating simultaneous transmission from multiple access points (APs). Wired, wireless devices or NTN devices may act as both repeater devices and secondary APs or secondary base stations which alternatively provide unique information to a mobile station. The network diagram of FIG. 3 is based on amendments to “Considerations on Joint Transmission” by Serizawa et al.

In an embodiment, control information 306 may be provided by a primary AP 302 which indicates wither the secondary AP 304 should repeat information transmitted over a wireless link between P-AP 302 and S-AP 304 and/or whether S-AP 304 should transmit unique information from the core network 308 (or another network) to the STA. The control information 306 may include: time information, beam information (which beams to use for S-AP 304 to reach the STA 310), switch information, for example information as to the radio conditions when to switch from a repeat mode to a unique data mode. One or both of the transmitters may be transmitting sensing and/or power based transmissions along with control and data transmissions. STA 310 may receive data 312 and/or data 314 from APs 302, 304. Time information may be used to specify an offset from a reference time or reference start time. In this way, S-AP 304 may act as both a repeater (which conditions are warranted) and as a unique data transmitter (again as conditions are warranted). The S-AP 304 may determine autonomously or via express signaling when to perform a repeat procedure vs when to transmit unique information. The STA 310 may indicate to either P-AP 302 or S-AP 304 a preference for repeat or unique. A STA may associate with one AP or another. There may be a channel load and/or number of STAs that exist within range of either AP that either AP uses to make a decision to act as a repeater or not. Either AP may report CQI information to the STA for forwarding to the other AP. APs may communicate such control information to one another over the wireless link, over a backhaul link, over a control link etc. it may be that aggregated links or asymmetric links are or are not employed.

Access points may send frames that have extended range preamble coupled with legacy preambles. An access point (for example, an 802.11 AP) may aggregate links and/or channels to form larger bandwidth transmissions to/from a wired or wireless device. There may be interference on some portion of the aggregated channel that the device may be able to predict, based on its own transmission/reception information and/or based on transmissions/receptions that are made by other devices occupying the channel bandwidth.

An 802.11 type trigger frame may set a duration, while data frames may not set a duration. The trigger frame may specify for each user, of a plurality of users, a bandwidth, gap location/size, transmission direction, etc. Alternatively, to save room in the trigger frame, one or a plurality of users may be scheduled using a same frequency and guard allocation within a channel. For example, for a transmission involving two users on 2 separate 20 mhz channels, a single puncturing pattern may specify a gap location and the 2 users may deduce a UL/DL channel allocation based on the channel bandwidth and the location of the gap, i.e. if the gap is 2.5 mhz wide at 12.5 mhz, there would be 12.5 mhz dedicated to a direction, e.g. downlink and 5 mhz dedicated to uplink (within a 20 mhz band). Certain channels may not operate at full duplex and may only operate at half duplex. Full duplex may be made available based on the use of movable/configurable antenna elements.

In embodiments, a device may report information on Bluetooth frequency/time/beam resources that are occupied or scheduled for its own Bluetooth transmissions. Alternatively, or in combination, a device may monitor the Bluetooth band and determine a transmission schedule that could potentially conflict with resource scheduling of the access point. For example, a device may decode a preamble (which length or width may vary), access address, error correction information, read a PDU header, cyclic redundancy check (CRC) etc.

The network may activate one or more configured grants for a wireless device based on information received from a device. A configured grant may be allocated for haptic feedback and another configured grant may be allocated for video/audio associated with the haptic feedback. The grants may be timed accordingly such that resources correspond to one another in time or frequency. For example, a resource used for TX/RX of haptic feedback may correspond to an integer offset from a resource used for a corresponding audio/video information associated with the haptic feedback. In another embodiment, a same configured grant may be used for both video and haptic data with a portion of the grant utilized for haptic information. Such portion may be used for video/audio if and only if there is no corresponding haptic information received in a time/frequency period. A haptic periodicity, haptic time offset, haptic message size, QoS info/latency information and destination information can be included in a request for resources and in response to the request for resources. A device may receive a configured grant for a period or, alternatively or in combination, may receive a configured grant and a plurality of DCI messages indicating resources for one or both of the video information and a haptic information transmission/reception. This may be true when haptic feedback is of a higher QoS and/or requires lower latency transmission than a corresponding video or other data segment associated with a feed of the haptic feedback.

A UE or base station may determine to use a shared key approach as opposed to another approach, for example, a noise injection approach, by predicting an adversary's noise channel conditions based on sensing of the environmental conditions, based on how strong one or more beams are to a legitimate receiver compared to a potential adversary. The network may provide RRC and DCI information indicating a type of physical layer security to employ and of course higher layer security may provide parameters for decision making at the UE in cases of transmission mode, for example, a sidelink transmission mode. Shared keys may be combined by using reception/transmit antennas which are each keyed, whereas each party knows each others key inherently. Physical layer security may also be employed (along with any other technique described herein) by using random seeds into a circular buffer or otherwise providing randomization at decoding once data is received. Random functions may be derived based on a previously selected identifier. For example, a random number may be an input to a next randomly generated number, for example, for securing a wireless channel.

In embodiments, devices may act as relays between certain other devices. For example, UEs may synchronize with multiple transmitted base stations within range depending on whether the network or base station is cell free or cell based. In embodiments, a cell based and cell free system may be employed service areas are and/or are not 1:1 correlated with a cell. For example, a service area may be configured on less than 1 cell and more than one cell.

RRC may provide, via UCI, MAC or RRC signaling: configuration information specifying a number of hops (e.g. max or min), Expected Transmission Count (ETX) routing characteristics, content parameters, and energy parameters, logical channel information, time, frequency, beam, channel information, cluster head, delay (or latency) parameters, distance, security, routing topology to use (according to any other parameters herein), QOS parameters, decision error rate, multicast, unicast, broadcast configurations, and other parameters including round trip time. The RRC or other signaling may provide information on multiple pathways from source to destination (and destination to source) [which may or may not be the same] and may include some redundancy information. The RRC may provide load distribution information according to latency requirements and other requirements of the UE. RRC may provide distance vectors, steering vectors and routing path optimization parameters.

Network elements, including base stations, may provide resource pools for UEs to only use for relay modes, i.e. when the UE is acting as a relay. Network nodes may provide resource pools to transmitting UEs which are different than the relay pools and those transmitting pools may be only used for relay transmission instead of the pools used for direct to UE transmission. In other words, a UE may be configured with separate pools for when transmitting directly to another destination UE or when transmitting source UE->UE->destination UE.

Nodes may report, via UCI, MAC or RRC signaling: residual energy, available bandwidth, and queue length. Nodes may send out pilot signals to UEs on separate channels and resources than base stations.

The UE may receive resource pools for route request packets, network setup packets and data packets. The UE may indicate resources for relay UEs to use, via SCI, based on the pool information configured by RRC or other layers. The resources for use by relay devices may be defined as an offset of the initial resources or chosen based on the initial choice which may be chosen at random by the initial UE.

UE may transmit assistance information including information to request additional resources for pools. The UE may receive a resource grant in response to the assistance information. The assistance message may be transmitted via a relay UE using resources that are dedicated, preconfigured or chosen via random access type transmission. The grant messages may contain parameters disclosed herein.

A header format may indicate whether a following segment is transmitted using unequal modulation. For example, the header format indicates a number of spatial streams implicitly by indicating a plurality of MCS indicators each representing the MCS of a separate stream. It may be that resource units are divided into a plurality of parts and separated in a time, frequency or beam manner, for example, in 3 or 4 parts. Certain formats may be specified for single user vs multi user formats or there may be a single transmission format employed. A transmitter may include, in a header portion of a frame, an indication of a beamforming change used to transmit a data portion which follows the header portion. For instance, a header portion may signal that the data portion (or chunks of discrete data portions) are being transmitted using a flexible beamforming technique.

A transmitting device may take into consideration charging parameters received from charging devices in a determination as to whether or not to perform sensing. For example, if a charging parameter exceeds a threshold, then the device may dedicate a certain percentage of resources to sensing. If the threshold is not met, the charging device may dedicate fewer or no resources to sensing.

Relay or intermediary devices may be located in between a wireless charging transmitter and a receiver. In some instances, intermediary devices may be cause for concern, e.g. a pair of keys or a device that could interrupt transmission or cause fire. In other instances, intermediary devices may be helpful, for example, phone stands or cases. In this case, intermediary devices may be identified using methods including integrated sensing and communication methods, RFID methods or the like. This way, a power transmitter may detect and identify an intermediary (which may also have a receive and transmit coil for powering a device) such that charging parameters may be varied or changed accordingly. In the case where a phone is placed on a stand, the stand may provide parameters to a transmitter for charging the phone on the stand. This way, the transmitter does not determine that the stand is a foreign object such and determine to not provide power. The transmitter may identify the intermediary object by determining its size, shape, material, orientation, orientation to the phone or charging device, whether the intermediary is a relay power/communication device, manufacturer, components, size, weight etc. The transmitter may be allowed internet access, via the phone being charged or via the intermediary device to determine an identifier and receive object classifications and charging parameters from an internet site, based on the detected sensing, RFID or other detection parameters. Power receivers, power transmitters, and power relays may detect or determine whether or not power should be supplied, how much power and for how long, based on cryptographic procedures disclosed herein. A certain charging power may be applied until a certain cryptographic procedure is performed in a receiving device and once the procedure is performed, then a higher level of power may be supplied until a second cryptographic procedure is completed. Then, and only then, may full power be supplied for some period. In some instances, a procedure may be applied without supplying any power to a device, e.g. by receiving information via backscatter only. It may be that a device is mechanically altered in such a way to provide cryptographic backscatter response, e.g. a mechanical reconfiguration may be performed on a receiving device at a time instant where the device has a certain power level above or below a threshold. Power transmitters may use results from the backscattering response and/or using integrated sensing and communication to determine placement of a device before applying any power. For example, in a wireless power scenario, a device may use joint resources to both sense objects in range, apply power and communicate.

Adaptive modulation may be employed, wherein same resources are dedicated for charging and sensing. Modulation formats like pulse interval modulation (PIM) and amplitude/phase shift keying (ASK/PSK) and linear frequency modulation (LFM) may be used in certain symbols/frequency portions of a transmission to modulate each one of sensing, power transmission and data transmission during a particular time period, e.g. a time slot, symbol, and the like. Modulations may be varied and thus may change over the course of a frame, e.g, wherein the frame provides some portions that are dedicated to power transmission, sensing and data communications. Underlying modulation scenarios may be changed according to thresholds, for instance, if sensing is to be applied, devices may use OTFS for frames and/or frame portions while using OFDM for other frames or frame portions when sensing may not be necessary. Thresholds may be used for switching. Similarly, certain devices may support OTFS only and may be used for sensing or may support OTFS and OFDM and may dedicate more OTFS resources (in the frequency or time domain) than OFDM. A split system may be employed wherein communication only devices are used for communication and sensing+communication devices are added interspersed. The sensing+communication devices may at first provide cell or carrier aggregation as opposed to stand alone services.

TABLE 1
Example frame transmission with sensing, power on and power off

| | | | | |
|---|---|---|---|---|
| | | | data | |
| guard | preamble | header | transmission | crc |

| | | | |
|---|---|---|---|
| sensing | power on | power off | power |

off

TABLE 2
Example Frame transmission sequence with sensing,
power off during tx and power on during reception

| | | | data trans- | | | |
|---|---|---|---|---|---|---|
| | | | mission + | | | UL data |
| | | | resource | | | trans- |
| guard | preamble | header | allocation | crc | guard | mission |
| sensing | power | power off | | power | no tx | Power on |
| | off | | | off | | |

In instances, when devices begin to apply transmit power, they may apply transmit power before it is necessary at a receiver by estimating the distance and blocking parameters in line of transmission. The power levels may be adjusted upwards if previous power transmissions have been successful or unsuccessful. Transmit power may be adjusted based on sensing results that indicate what type of beam (e.g. shape, size) will be used to transmit power and/or data.

When resources are dormant, they may be used for low priority monitoring applications. For example, the literature provides many examples of forest fire monitoring methods using imaging and communication devices, e.g. satellites, radar, doppler, lidar and the like. In examples, satellite devices may periodically report an ability to perform imaging in certain areas when an imaging device is not being utilized by another application. They may periodically report an available bandwidth or report in instances where an available bandwidth is above a threshold for a particular monitoring application in a direction or beam coverage areas. Similarly, terrestrial devices including cellular and wi-fi compliant base stations may have doppler and integrated sensing functionality that may be used for a similar or same application. These devices may report an ability to use spectrum that is not otherwise dedicated to data communications to perform fire monitoring or other safety related applications.

Devices which perform ambient IoT frame exchange methods, in embodiments, may have only a single oscillator and/or single antenna and may be relegated to operation in one or more FDD modes. For example, some devices that may have only a single oscillator may be triggered for data transmission on a same frequency as the trigger frame is received and other devices may be triggered for data transmission on a different frequency. In examples, a reader to device (R2D) trigger may trigger devices A and B to respond on the same frequency, f1, as the R2D trigger is sent on. Other devices, e.g. devices C and D, which may be FDD compliant devices with dual antennas and dual oscillators, may transmit on a different frequency, f2. So, this embodiment allows TDD and FDD devices to share frequency resources.

The above outlined procedure of triggering some devices on a same frequency and some devices on another frequency may apply to devices other than Ambient IoT devices and may apply for control transmissions, data transmissions etc. The triggering may be based on priority, power/battery level at the device side, and/or number of oscillators. The trigger frame may specify gaps in time/frequency domain for scheduling devices. The trigger frame may omit an MCS for certain devices or all devices. The trigger frame may specify an MCS for some devices. The trigger frame may comprise a priority indicator which indicates a priority level and above for transmission and/or a transmission order for certain priority devices. In embodiments, a device may have two separate transceivers configured for reception on two different frequencies. For example, a device may receive and transmit on f1 (as per above) and then activate a transceiver for f2 once information is received on f1 indicating the turn on condition.

Trigger frames and/or header formats and/or device to reader and/or reader to device message may provide information based on device type, for example, they may include a capability indicator including a capability of supporting one or more of CDMA, OFDMA or TDMA, a capability of participating in group based uplink or downlink exchange, capability for versioning, a capability of prioritized access, e.g. based on power or the like. Certain deployment methods may be better for low power devices, for example, low power devices may be configured to use limited bands or bandwidth as compared to other devices. In embodiments, trigger frames may be used to trigger some devices for responding at X khz while other devices are triggered for responding at X*2 and/or X*4 khz etc. Some devices may be capable of supporting an ALOHA and/or BTree algorithm for collision handling.

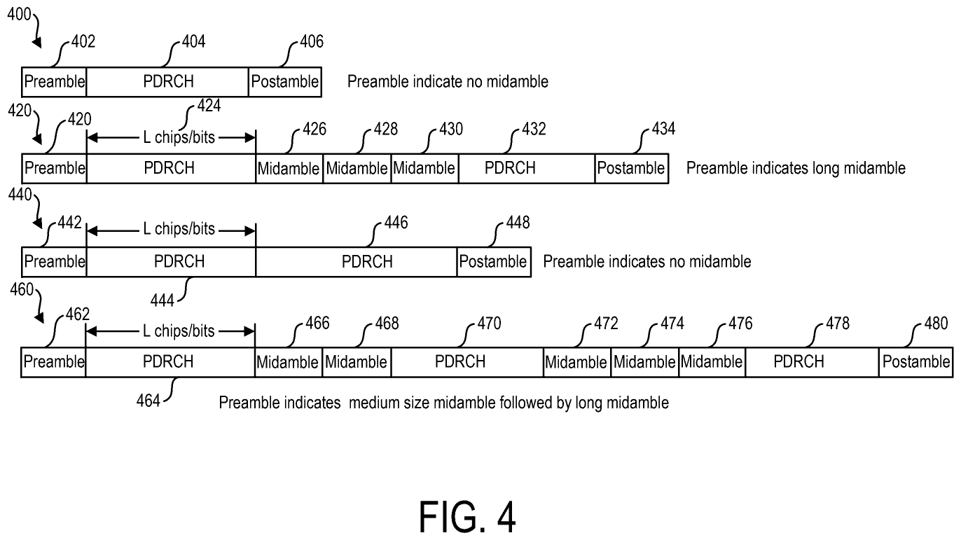

FIG. 4 is a diagram illustrating prospective packet formats 400, 420, 440, 460, wherein midamble lengths are indicated. Packet format 400 includes a preamble 402, Physical Device-to-Reader Channel (PDRCH) 404 and postamble 406. The preamble 402 indicates that no midamble is used in this configuration. Packet format 420 includes a preamble 422, PDRCH 424, a first midable 426, second midable 428 and third midamble 430, another PDRCH 432 and a postamble 434. The preamble 402 indicates that a long midable, i.e. three midables portions 426, 428, 430 are employed in this configuration. Packet format 440 includes a preamble 442, PDRCH 444, PDRCH 446 and postamble 448. In this example, the preamble indicates no midamble, but indicates a repeat of the PDRCH 444, 446. In another example packet format 460, a preamble 462 indicates that a PDRCH 464 and two midables 466, 468 will follow. The preamble 462 also indicates that a PDRCH 470 follows midable 468 and that three midambles 472, 474, 476 follow PDRCH 470. The preamble 462 indicates that another PDRCH 478 follows midable 476 and a postamble 480 follows PDRCH 478. While the figure shows a PDRCH transmission, one of ordinary skill in the art will recognize that a Physical Reader-to-Device Channel (PRDCH) may be employed instead.

In embodiments, a preamble may indicate a preamble configuration, midamble configuration and postamble configured. For example, a preamble may include a size, number of fields or length indicator to specify the size, number of fields or length of a preamble midamble or postamble. The indicator may be a relative indicator, e.g. 0, 1, or 2 etc. to denote no midamble, single midamble, double midamble, triple midamble, and so forth. Devices may deduce midamble length based on other message characteristics or indicators. Preamble, midamble and postamble portions may indicate a time period or number of packets for which a device may be expected to maintain certain information, e.g. state information and/or connectivity information. Devices may have two or more part receivers such that one receiver is on while another is off. For more details, see 3GPP TSG RAN WG1 #119 Document id #R1-2409898 Orlando, US, November 18th-22nd, 2024.

Mechanisms are in place to ensure continuity if one or more leader devices fails. A threshold-based fallback protocol may be used to switch over when a device becomes unresponsive. A reliability monitoring module continuously monitors acknowledgments (ACKs) from Beacon and Trigger Frames. Once a failure is detected, a role switch procedure may take place. The latest synchronized data that is received may be employed. An enhanced beacon frame may be broadcast to notify devices of a leadership change. This broadcast frame may include an updated leader status flag.

A trigger frame generator may be responsible for generating trigger frames that inform a device's readiness to transmit. A trigger frame may contain information such as device identifier, backoff completion status, current backoff value, free-riding status flag, and a synchronization timestamp to ensure that the transmission is synchronized.

A trigger frame constructor may proceed to assemble a trigger frame with the relevant data. Once the trigger frame is constructed, the frame queue manager queues and manages the scheduling of trigger frames, managing any retries triggered by the ACK handler. The transmission module may or may not transmit this data once it is ready. The ACK handler waits for an acknowledgement to ensure that the trigger frame has been successfully received. If an ACK is not received, the ACK handler initiates a retry as needed.

A backoff compensation coordinator may be responsible for managing backoff compensation in a way that prevents backoff count overflow. Two inputs may be relied on: the aggregated congestion level from the congestion aggregator and the updated free-riding limits from the adaptive free-riding control module.

If the current backoff count is already high, the module limits the compensation value to a manageable level to ensure that the total backoff does not grow excessively large. The limit itself is dynamically adjusted based on the congestion state. For example, in a congested network, the compensation limit might be set to a very low value or even to zero, effectively disallowing compensation for free-riding actions. Alternatively, in a lightly loaded network, the limit may be increased.

A trigger frame coordinator is a module responsible for managing and synchronizing transmissions to ensure that devices are in sync when initiating transmissions.

The Trigger Frame Coordinator takes three key inputs. First, it receives trigger frames from the trigger frame generators. These frames contain information, such as the device identifier, backoff completion state, current backoff value, free-riding status flag, and synchronization timestamp, which collectively indicate the readiness for a synchronized joint transmission. Internal synchronization information may include the current state of synchronization and may be used to determine whether adjustments are needed for maintain coordination. Last, it receives acknowledgement (ACK) feedback. The coordinator receives feedback on whether previous frames were successfully acknowledged.

Several sub-modules work in tandem within the trigger frame coordinator to process these inputs. After receiving a trigger frame, a device may send an ACK back to the follower AP to confirm successful receipt. The trigger frame reception handler verifies validity and determines which devices are ready for joint transmission based on free-ride status and backoff completion status.

The trigger transmission coordinator may be responsible for tracking ACKs of synchronized instructions. After trigger frames are broadcast, ACKs are monitored to confirm successful receipt. If the data is received, the trigger transmission coordinator may send back an ACK to the trigger frame generator. If communication reliability falls below a defined threshold, a fallback mechanism is defined.

A reliability analyzer may be used to evaluate the reliability of communication by assessing the success rate of received ACKs for trigger frames and beacon frames. It may calculate a reliability score by measuring the percentage of successfully acknowledged frames over a given time period. If the reliability score falls below a defined threshold, this sub-module alerts indicating a potential issue.

Trigger frames may be used in real-time to synchronize the start of transmission for devices. When a device finishes its backoff countdown and is ready for transmission, it sends a frame which is received and processed through a receiving trigger frame coordinator. The coordinator processes received frames and coordinates an exact moment when devices should initiate transmission.

A device may broadcast a synchronized command through a beacon frame, ensuring all devices are aware of the precise time to start transmission. A synchronization timestamp may be used to align the start of all transmissions. Internal clocks may be aligned to ensure that any discrepancies in timing are corrected.

In the event that a beacon frame is not received in time, a device may wait for the next beacon frame with an updated synchronization timestamp. A reliability monitoring module monitors ACKs to ensure that synchronization updates are delivered. Retransmission of the synchronization information may be triggered if no acknowledgement is received.

Although the features and elements disclosed are described in the embodiments in particular combinations, each feature or element can be used alone without the other features and elements of the embodiments or in various combinations with or without other features and elements of the present disclosure. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method performed by a wireless device in communication with a reader, the method comprising:
transmitting an energy parameter, to the reader, using one modulation method of the group consisting of On-Off Keying (OOK) and Phase Shift Keying (PSK);
transmitting assistance information, to the reader, wherein the transmitted assistance information comprises at least a message size pertaining to the device, wherein the reader is configured to receive assistance information about the device independently from the device and from another device; and
transmitting a message, having a cyclic prefix, wherein the message is consistent with the message size, on a bandwidth negotiated between the wireless device and the reader;
wherein the wireless device and the reader are configured to communicate according to at least one application layer identifier having a random portion and a non-random portion, wherein the at least one application layer identifier is configured to be of at least two different lengths, wherein the at least two different lengths include a full length and a partial length.

2. The method of claim 1, wherein communication between the wireless device and the reader occurs on the negotiated bandwidth.

3. The method of claim 1, wherein the selected modulation is one of OOK and PSK, wherein the selected modulation employs at least two tones.

4. The method of claim 1, wherein a CRC length is selected based on information that precedes the CRC, wherein the information that precedes the CRC is of a first length or a second length, wherein the second length is different than the first length.

5. The method of claim 4, wherein a CRC is not employed.

6. The method of claim 1, wherein a midamble sequence is variably employed.

7. The method of claim 1, wherein in a first mode, contention based access is provided between the device and the reader and in a second mode, contention free access is provided between the device and the reader.

8. The method of claim 7, further comprising:
detecting, during the contention based mode, that a failure occurred; and
processing a trigger based message, wherein the trigger based message indicates backoff.

9. The method of claim 8, further comprising:
transmitting a message, by the device, the message transmitted at a time instance consistent with the trigger based message.

10. A system comprising:
a device; and
a reader;
wherein the reader is configured to receive an energy parameter, from the device, in a transmission from the device to the reader;
wherein the reader is configured to receive assistance information about the device independently from the device and from another device, wherein the assistance information comprises at least a message size of the device;
wherein the device and the reader are configured to communicate according to at least one application layer identifier, which is configured to be of at least two different lengths, wherein the at least two different lengths include a full length and a partial length;
wherein the application layer identifier has a random portion;
wherein a sequence number is not employed;
wherein modulation methods include one or both of On-Off Keying (OOK) and Phase Shift Keying (PSK).

11. A method performed by a wireless device in communication with a reader, the method comprising:
transmitting an energy parameter, to the reader, using one modulation method of the group consisting of On-Off Keying (OOK) and Phase Shift Keying (PSK);
transmitting assistance information, to the reader, wherein the assistance information comprises at least a message size pertaining to the device; and
transmitting a message, having a cyclic prefix, wherein the message is consistent with the message size, on a bandwidth negotiated between the wireless device and the reader.
